(19) United States
(12) Patent Application Publication
(10) Pub. No.: US 2005/0100479 A1
(43) Pub. Date: May 12, 2005

(54) Air wound gas chromatography column and assembly

(76) Inventors: Richard P. White, Glen Mills, PA (US); William E. Trescott, Wilmington, DE (US); Clayton E. Law, Malvern, PA (US); Alan D. Loux, Newark, DE (US)

Correspondence Address: Thomas X. Li;AGILENT TECHNOLOGIES, INC., Intellectual Property Administration, P.O. Box 7599, Loveland, CO, 80537-0599, US

(21) Appl. No.: 10/703,603

(22) Filed: Nov. 10, 2003

(51) Int. Cl. G01N 30/02

(52) U.S. Cl. 422/88; 436/161

(57) ABSTRACT

A column installation assembly for a Micro Gas Chromatograph that includes a coiled column is described. The assembly also includes a mechanism within the Micro Gas Chromatograph for removably securing the coiled column in place. A method for preparing a column for installment in a Micro Gas Chromatograph is also described

### FIELD OF THE INVENTION

The present invention relates to chromatography equipment and column assembly.

### BACKGROUND OF THE INVENTION

In gas chromatography (“GC”), the apparatus incorporated within the instrument that houses the column, is sometimes referred to as the column basket. As the columns are typically arranged in some form of coil, the size of the column basket is described in terms of its diameter. The diameter of the column basket generally dictates the size of the oven, which in turn dictates the overall size of the entire instrument size. Additionally, oven size and temperature needs dictate the power requirements of the instrument. In some markets there is a need for significantly smaller and faster gas chromatographs than the commonly available gas chromatograph. To those skilled in the art, this type of instrument is known as Micro GC.

Currently, Micro-GCs include columns wound down to small diameter (˜2″) inside a copper can. The column is manually positioned inside the can by a process of winding the column into the can where it expands inside the copper can. In some instances, multiple columns are wound down and expand inside the copper can. The copper can with the column or columns is then installed into the Micro GC where it serves as the oven. This arrangement and process for installation has several drawbacks.

First, Columns would by hand into cans is time-consuming and expensive. The entire installation process is typically performed by a skilled technician where the Micro GC is assembled for commercial use. As a result the end user cannot simply change columns or make repairs in the field. The entire unit must be shipped back to the manufacturer in order to change a column.

Second, manual winding, in a small fixed can, limits the length of column that can be used in the assembly. As the column fills the can from the outside diameter inwards, the volume of the can and the column minimum bending radius limits how much material can fit in the oven, and therefore the maximum column length provided. Longer length columns are especially problematic and can only be handled through special hand wound processing. Column integrity and lifetime are a function of bending radius. Damage to column material is cumulative, such that material drawn over a small radius even for short periods may experience significant reductions in expected lifetime. The process of overbending the column material to fit it inside the current can configuration necessarily reduces its lifetime. Currently, column lengths are limited to about 14 meters before problems arise with the installation.

Third, manual winding can be detrimental to the integrity of the column itself. The column packing or stationary phase can be disrupted by the process of winding it inside the can. Winding PLOT (Porous Layer Open Tubular) columns in particular degrades the internal coating by over bending the column during assembly, creating fractures in the brittle internal coating, producing shards or dust of stationary phase, which can degrade chromatography or adjacent devices such as micro injector valves.

What is needed is a method of installing columns in a Micro GC that avoids manual winding of the column into the copper can. Further, an apparatus that allows easy installation and removal of the columns in a Micro GC is needed. It would be particularly advantageous to be able to easily and reliably install longer columns.

### SUMMARY OF THE INVENTION

A column installation assembly for a Micro Gas Chromatograph that includes a coiled column is described. The assembly also includes a mechanism within the Micro Gas Chromatograph for removably securing the coiled column in place.

### BRIEF DESCRIPTION OF THE DRAWINGS

The accompanying drawings are incorporated in and constitute a part of this specification and, together with the description, explain the advantages and principles of the invention. In the drawings,

FIG. 1 is a perspective view of an air wound column around the winding template;

FIG. 2 is a perspective view of an air wound column with a portion of the column fastened in position using ties with the winding template removed;

FIG. 3 is plan view of a Micro GC configured to receive an air wound column;

FIG. 4 is a plan view of a Micro GC with an air wound column placed in position;

FIG. 5 is a plan view of a Micro GC with an air wound column installed in the Micro GC.

### DETAILED DESCRIPTION

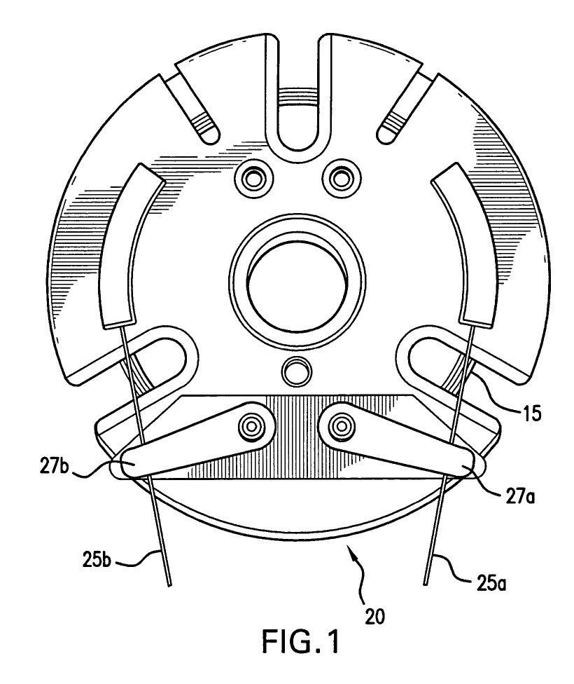

Turning now to the drawings, FIG. 1 illustrates an embodiment of an air wound column of the invention. The majority of the column 10 is wound in a coil 15 around a winding template 20. A length of each end 25a and 25b of the column 10 remains unwound from the coil 15.

Preferably, the column 10 is wound around the winding template 20 using an automated respooling apparatus. While some column material is available in bulk spools, most analytic column material must be purchased in 30 meter or shorter lengths, already wound onto a conventional basket. In this instance, to the column is unwound from the basket onto a temporary spool without introducing any scratches, foreign material, twists or other stresses to the material. In particular, it is important not to bend the material to the extent that it would introduce large lifetime reducing stresses. From the temporary or bulk spool, the column material is metered through a tensioning device to the winding template 20. A uniform small tension is important to feeding the material onto the template and ensuring it coils uniformly rather than stack up and collapse, leaving crossing tubing and internal voids in the bundle. Additionally, the tension also reduces the tendency of the relatively stiff tubing to spring out of the template before the assembly operation is complete. The metering of column length onto the template is preferably a non-contact operation. When the final length (typically 2-12 meters, but occasionally up to 30 meters) is counted onto the coil, a length of column at each end 25a and 25b is left un-looped and unsecured from the coil 15 of the assembled column and are fastened to the template with fastening devices 27a and 27b. Then, the column is severed, and the template is removed from the winding machine.

The internal diameter of the winding template is larger than the typical internal diameter of manually wound columns that are used inside of the copper can of conventional Micro GCs. As a result, this method of preparing the coil 15 places minimal stress on the integrity of the column packing and tubing. The preferred winding template 20 is a Teflon coated bobbin or spool. A Teflon coated bobbin or spool is easily removed from the coil 15 once the coil 15 is secured in shape, as discussed below. Although not required, it is preferred that the winding template 20 be removed from the coil 15 prior to use in a Micro GC as it may affect the heat distribution and overall performance once in place.

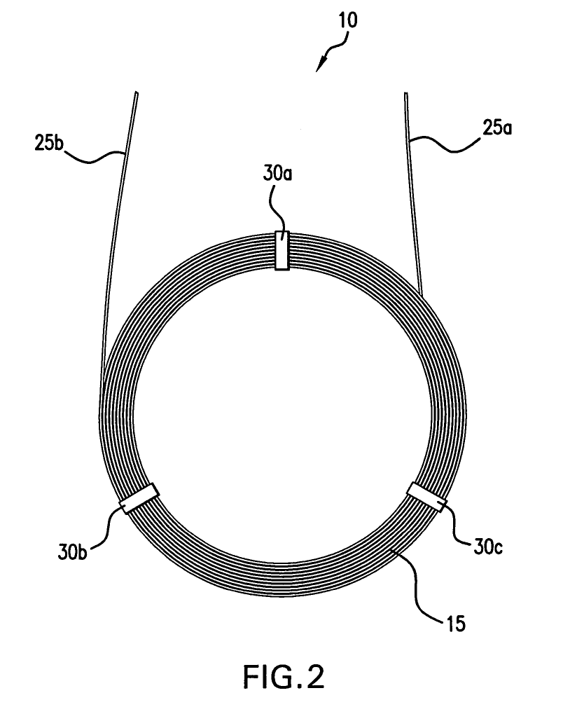

Once the column 10 is coiled around the winding template 20, at least a portion of the coil 15 must be secured or fasted in coil shape so that it does not uncoil or unravel when being handled. FIG. 2 illustrates the preferred method of securing the coil 15 using physical fastening devices. Twist ties 30a, 30b, and 30c of high temperature tape or string are fastened around the coil 15 positioned at approximately equidistant points around the circumference of the coil 15. Twist ties 30a 30b, and 30c are twisted tightly enough so that the coil 15 does not unravel but not so tightly that it damages the column 10. FIG. 2 shows the use of three twist ties to fasten the coil 15, however, less or more could be used to obtain the level of fastening needed. Additionally, other devises can be used in place of twist ties 30. Non-limiting examples such as wire or clips can also be used.

Additional methods for securing or fastening the coil 15 can also be used. In one embodiment, an adhesive (not shown) is applied while the coil is still positioned on the winding template 20. The adhesive is cured prior to the subsequent removal of the coil 15 from the winding template 20. The preferred adhesive is EPO-TEK 353ND, however other adhesives may be used. One advantage of epoxy adhesive, and to some extent high temperature tape, is that the regular cross section of the coiled column is retained, making precision fitting into the oven assembly of the Micro-GC easier, providing more uniform temperature for good chromatography. The effect of temperature on the adhesive is an important factor to consider when choosing a suitable adhesive. Also, its potential reactivity with the coating of the column 10 is another important factor.

A length of column at each end 25a and 25b is left un-looped and unsecured from the coil 15. The precise length left unsecured and un-looped at each end 25a and 25b is not critically important and can vary from application to application. The length must be long enough so that it may be properly installed in a Micro GC (discussed below). In the preferred embodiment, the final loop of each end 25a and 25b of the column 10 within the coil 15 is left unsecured as well. These unsecured loops are sometimes referred to service loops. The presence of service loops assists in the installation and service of the column 10.

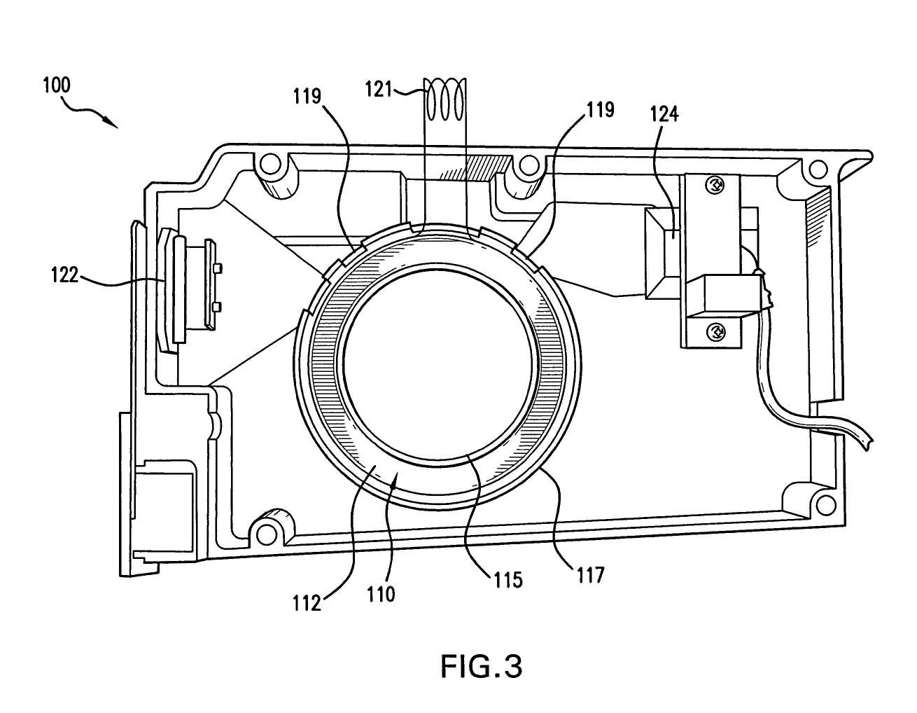

FIG. 3 illustrates an inside view of a Micro GC 100 configured for installation of a pre-wound column. A circular groove 110 is positioned inside the Micro GC 100 and dimensioned to receive the coil 15 of a pre-wound column (not shown). The cylindrical groove 110 is formed from a circular outer wall 117. The back 112 of the cylindrical oven groove 110 is preferably lined with copper for its heat conducting properties and preferably includes a heater 121, bonded to the copper lining. The width of the groove 110 is preferably large enough to house multiple columns at once. The outer wall 117 is constructed from the same material as the housing of the Micro GC, which is typically high temperature plastic. Optionally, the groove may also be bordered on inner side of the groove with an inner wall 115, which is concentric to with the outer wall 117. Preferably, the inner and outer walls 115 and 117 are integral with the back wall of the housing, however, they need not be. The inner wall 115 is generally unbroken, while the outer wall 117 has a number of breaks 119 to allow for the ingress and egress of the column ends 25a and 25b (not shown). The remainder of the Micro GC is generally configured as a conventional Micro GC. One end has an injector 122 and the other end has a detector 124. The specific type and position of the injector 122 and detector 124 can vary and will depend on the specific requirements of the user.

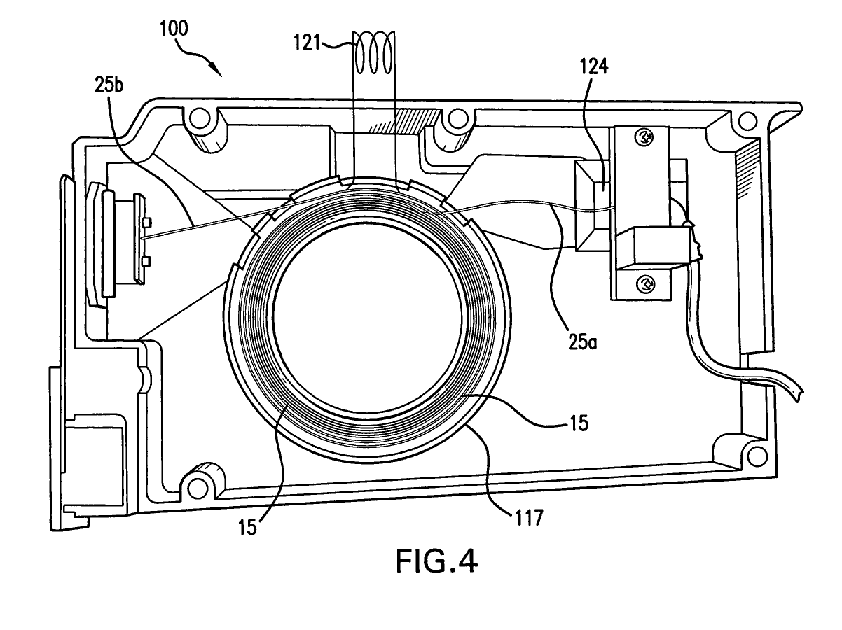

FIG. 4 illustrates an inside view of the Micro GC 100 with a column 10 installed in position. The coil 15 of the pre-wound column 10 is placed in the groove 110. The ends 25a and 25b are positioned out of the groove 110 through one of the breaks 119 in the outer wall 117 of the groove 110. In order to provide some length adjustment, the free ends 25a and 25b of the column are preferably looped around inside the wall 117 to create a service loop. This provides enough axial travel for each column end for dressing or assembling it into the next device without requiring precision trimming and location. Typically, one end 25a will exit the groove 110 in the direction of the detector 124 and the other end 25b will exit the groove 110 in the position of the injector 122.

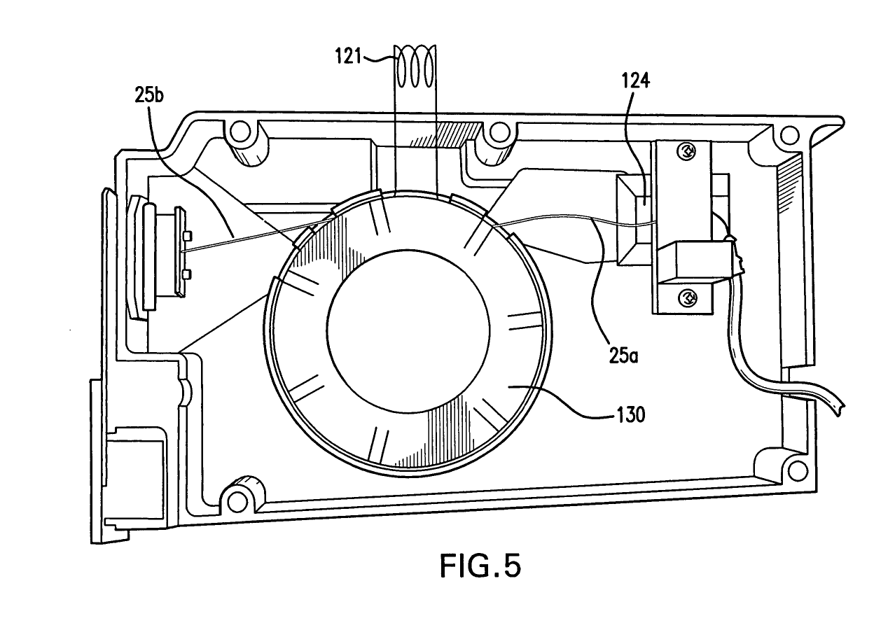

Once the column 10 is installed, a lid 130 is placed over top of the column 10 to complete the installation. FIG. 5 illustrates the installation of the column 10 with the lid 130 in place. The lid 130 is also preferably constructed from copper. Other materials may be used, however the thermal properties of the material are a consideration. The lid 130 is dimensioned to fit firmly inside the outer wall 117 of the groove 110. Clamping devises may also be used to hold the lid in place. Once the lid 130 is secured, the column ends may be coupled to the upstream and downstream devices.

1. A method for preparing a column for installment in a Micro Gas Chromatograph comprising the steps of:
winding the column on a winding template to form a coiled column assembly; and
securing in position at least a portion of the coiled column assembly, wherein a length of column at each column end remains unsecured to the coiled column assembly.

2. The method of claim 1, wherein the portion of spooled column assembly is secured in position by the application of an adhesive.

3. The method of claim 1, wherein the portion of spooled column assembly is secured in position by twist ties.

4. The method of claim 1 further comprising the step of removing the winding template from the coiled column assembly after at least a portion is secured in position.

5. A column installation assembly for a Micro Gas Chromatograph comprising:
a coiled column;
a mechanism within the Micro Gas Chromatograph for removably securing the coiled column in place.

6. The column installation assembly of claim 5 wherein the mechanism for removably securing the spooled column in place comprises an integral channel positioned within the Micro Gas Chromatograph and dimensioned to receive a coiled capillary column and a lid for the integral channel dimensioned to cover the channel after installation of the coiled capillary column.

7. The column installation assembly of claim 6 wherein the integral channel has a base made of copper.

8. The column installation assembly of the claim 7 wherein the lid is made of copper.

9. The column installation assembly of claim 8 wherein the integral channel is bordered by an inner wall and a concentric outer wall, wherein the inner wall and outer wall are perpendicular to the base of the channel.

10. The column installation assembly of claim 5 wherein the outer wall has a plurality of breaks.

11. The column installation assembly of claim 5 wherein the spooled column is prepared by winding the column on a winding template to form a hollow spooled column assembly; and securing in position at least a portion of the spooled column assembly, wherein a length of column at each column end remains unsecured to the spooled column assembly.

12. A Micro Gas Chromatograph comprising:
an integral channel positioned within the Micro Gas Chromatograph and dimensioned to receive a coiled capillary column;
a lid for the integral channel dimensioned to cover the channel after installation of the coiled capillary column.

13. The Micro Gas Chromatograph of claim 12 wherein the integral channel has a base made of copper.

14. The Micro Gas Chromatograph of claim 12 wherein the lid is made of copper.

15. The Micro Gas Chromatograph of claim 12 wherein the integral channel is bordered by an inner wall and a concentric outer wall, wherein the inner wall and outer wall are perpendicular to the base of the channel.

16. The Micro Gas Chromatograph of claim 15 wherein the outer wall has a plurality of breaks.

17. The column installation assembly of claim 7 wherein the spooled column is secured in position by tape.

18. The column installation assembly of claim 7 wherein the copper base includes an intimately bonded heater assembly.

19. The Micro Gas Chromatograph of claim 14 wherein the copper base includes an intimately bonded heater assembly.

20. The column installation assembly of claim 7 wherein the spooled column is secured in position by the application of an adhesive.
